(19) United States
(12) Patent Application Publication
(10) Pub. No.: US 2005/0237664 A1
(43) Pub. Date: Oct. 27, 2005

(54) Construction of a servo writing device

(76) Inventor: Li-Ping Zhao, Milpitas, CA (US)

Correspondence Address: Yi-Ming Tseng, P.O. Box 19428, Stanford, CA, 94309-9428, US

(21) Appl. No.: 11/112,874

(22) Filed: Apr. 21, 2005

Related U.S. Application Data
(60) Provisional application No. 60/564,352, filed on Apr. 21, 2004.

(51) Int. Cl. G11B 33/14; G11B 21/02

(52) U.S. Cl. 360/97.02

(57) ABSTRACT

One embodiment of the present invention is a servo writing device comprising: (a) a servo track writer assembly that is adapted to write servo tracks; (b) a base that is adapted to support the servo track writer assembly; and (c) an adhesive damping layer that that is: (i) disposed between the servo track writer assembly and the base; and (ii) adapted to connect the servo track writer assembly and the base.

This application claims the benefit of U.S. Provisional Application No. 60/564,352, filed on Apr. 21, 2004 and which is incorporated herein by reference.

### TECHNICAL FIELD OF THE INVENTION

One or more embodiments of the present invention relate to disk drive manufacturing equipment, and more particularly, to assembly of a servo tracking writing device for disk drives.

### BACKGROUND OF THE INVENTION

In manufacturing disk drives, servo tracks are typically written onto a disk, which servo tracks are utilized to guide movement of, and to position, read/write heads precisely. The servo tracks are meant to be concentric circles, and they can be written onto the disk using a servo writing device. The servo writing device includes: (a) a servo track writer (STW) assembly that is adapted to write the servo tracks; and (b) a base that is adapted to support the STW assembly. The STW assembly typically includes the following components: an enclosure, a controller, an actuator, a pushpin block, and a head stack assembly, wherein: (a) the enclosure encloses the actuator, supports the other components, and supports the disk; (b) the controller controls the actuator; (c) the actuator drives the pushpin block; (d) the pushpin block drives the head stack assembly; and (e) the head stack assembly writes the servo tracks. The base typically includes a platform made of a stiff material such as, for example and without limitation, granite or steel; and the base may further include leg structures, which are also made of a stiff material such as steel.

Conventionally, in constructing the servo writing device, the STW assembly is connected to the base by using a plurality of mounting screws, and a bottom surface of the STW assembly directly contacts a top surface of the base. As a result, vibrations in an operating environment of the servo track writing device typically transmit through the base to the STW assembly, thereby contributing to errors in the servo tracks.

In light of the above, there is a need in the art for a servo writing device that solves one or more of the above-identified problems.

### SUMMARY OF THE INVENTION

One or more embodiments of the present invention solve one or more of the above-identified problems. In particular, one embodiment of the present invention is a servo writing device comprising: (a) a servo track writer assembly that is adapted to write servo tracks; (b) a base that is adapted to support the servo track writer assembly; and (c) an adhesive damping layer that that is: (i) disposed between the servo track writer assembly and the base; and (ii) adapted to connect the servo track writer assembly and the base.

### BRIEF DESCRIPTION OF THE DRAWING

FIG. 1 shows a servo writing device that is fabricated in accordance with one or more embodiments of the present invention; and

FIG. 2A shows a top view of another servo writing device that is fabricated in accordance with one or more embodiments of the present invention; and

FIG. 2B shows a front view of the servo writing device shown in FIG. 2A.

### DETAILED DESCRIPTION

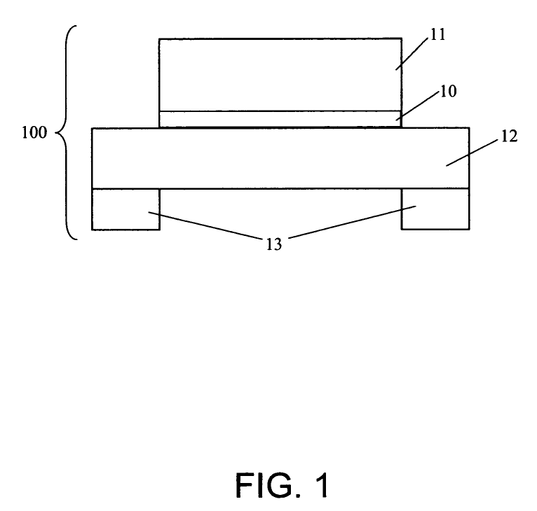

FIG. 1. shows servo writing device 100 that is fabricated in accordance with one or more embodiments of the present invention. As shown in FIG. 1, servo writing device 100 includes servo track writer assembly 11 (STW assembly 11), adhesive damping layer 10, base 12, and leg structures 13, wherein base 12 stands on leg structures 13 and supports STW assembly 11 through adhesive damping layer 10. STW assembly 11, base 12, and leg structures 13 include conventional components and materials that are well known in the art. In accordance with one or more embodiments of the present invention, adhesive damping layer 10 is: (a) disposed between STW assembly 11 and base 12; and (b) adapted to connect STW assembly 11 and base 12 by adhering its top surface to a bottom surface of STW assembly 11 and adhering its bottom surface to a top surface of base 12. In accordance with one or more embodiments of the present invention, adhesive damping layer 10 includes a constrained damping layer material that is commercially available from suppliers such as, for example and without limitation, Aearo Company (www.aearo.com) of Indianapolis, Ind., adhesive, and contains loose sections that rub each other under vibration, thereby converting vibration energy into heat energy.

As one of ordinary skill in the art can readily appreciate, in any particular embodiment, the material, shape, and dimensions of adhesive damping layer 10 may be determined by how much bonding force between STW assembly and base a designer of the servo writing device wants, how the designer wants the bonding force to be distributed, and how much vibration the designer wants adhesive damping layer 10 to dissipate. As is well known, different servo writing device designs and operating environments might have different bonding force and vibration dissipation requirements. As such, the material, shape, and dimensions of adhesive damping layer 10 for a particular servo writing device design may be determined by one of ordinary skill in the art routinely and without undue experimentation utilizing any one of a number of methods that are well known to one of ordinary skill in the art such as, for example and without limitation, finite element analysis.

In accordance with one or more embodiments of the present invention, adhesive damping layer 10 has a top surface that has substantially the same area and shape of a bottom surface of STW assembly 11. In accordance with one or more embodiments of the present invention, adhesive damping layer 10 includes a plurality of discrete adhesive damping units.

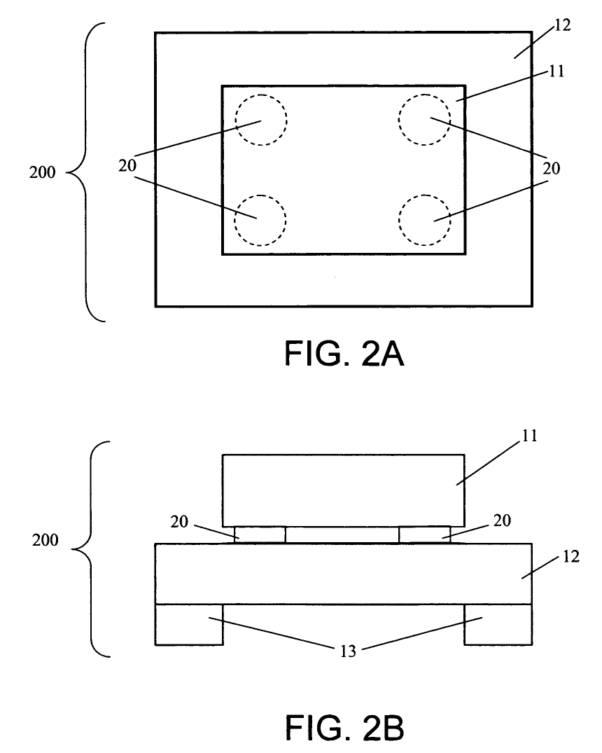

FIG. 2A shows a top view of servo writing device 200 that is fabricated in accordance with one or more embodiments of the present invention; and FIG. 2B shows a front view of servo writing device 200. As shown in FIGS. 2A and 2B, servo writing device 200 includes servo track writer assembly 11 (STW assembly 11), adhesive damping pads 20, base 12, and leg structures 13, wherein base 12 stands on leg structures 13 and supports STW assembly 11 through adhesive damping pads 20. STW assembly 11, base 12, and leg structures 13 include conventional components and materials that are well known in the art. In accordance with one or more embodiments of the present invention, adhesive damping pads 20 are: (a) disposed between STW assembly 11 and base 12; and (b) adapted to connect STW assembly 11 and base 12 by adhering their top surfaces to a bottom surface of STW assembly 11 and adhering their bottom surfaces to a top surface of base 12. In accordance with one or more embodiments of the present invention, adhesive damping pads 20 includes a constrained damping layer material that is commercially available from suppliers such as, for example and without limitation, Aearo Company (www.aearo.com) of Indianapolis, Ind., adhesive, and contains loose sections that rub each other under vibration, thereby converting vibration energy into heat energy.

As one of ordinary skill in the art can readily appreciate, in any particular embodiment, the material, shape, dimensions, and number of adhesive damping pads 20 may be determined by how much bonding force between STW assembly and base a designer of the servo writing device wants, how the designer wants the bonding force to be distributed, and how much vibration the designer wants adhesive damping layer 10 to dissipate. As is well known, different servo writing device designs and operating environments might have different bonding force and vibration dissipation requirements. As such, the material, shape, dimensions, and number of adhesive damping pads 20 for a particular servo writing device design may be determined by one of ordinary skill in the art routinely and without undue experimentation utilizing any one of a number of methods that are well known to one of ordinary skill in the art such as, for example and without limitation, finite element analysis.

Advantageously, a servo writing device fabricated in accordance with one or more embodiments of the present invention: (a) eliminates requirements for mounting screws, thereby reducing machining costs for its STW assembly and base; and (b) dissipates vibration from its operating environments, thereby reducing errors in servo track writing.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A servo writing device comprising:
a servo track writer assembly that is adapted to write servo tracks;
a base that is adapted to support the servo track writer assembly; and
an adhesive damping layer that that is: (a) disposed between the servo track writer assembly and the base; and (b) adapted to connect the servo track writer assembly and the base.

2. The servo writing device of claim 1 wherein the adhesive damping layer comprises:
a top surface that adheres to a bottom surface of the servo track writer; and
a bottom surface that adheres to a top surface of the base.

3. The servo writing device of claim 1 wherein the adhesive damping layer has a top surface that has substantially the same area and shape of a bottom surface of the servo track writer assembly.

4. The servo writing device of claim 1 wherein the adhesive damping layer comprises a plurality of discrete units.

5. The servo writing device of claim 1 wherein the adhesive damping layer comprises loose sections that rub each other under vibration, thereby converting vibration energy into heat energy.

6. The servo writing device of claim 1 wherein the adhesive damping layer comprises a constrained damping layer material.

7. A servo writing device comprising:
a servo track writer assembly that is adapted to write servo tracks;
a base that is adapted to support the servo track writer assembly; and
one or more adhesive damping pads that that are: (a) disposed between the servo track writer assembly and the base; and (b) adapted to connect the servo track writer assembly and the base.

8. The servo writing device of claim 7 wherein the one or more adhesive damping pads connect the servo track writer assembly and the base by:
adhering to a bottom surface of the servo track writer; and
adhering to a top surface of the base.

9. The servo writing device of claim 7 wherein the one or more adhesive damping pads comprise loose sections that rub each other under vibration, thereby converting vibration energy into heat energy.

10. The servo writing device of claim 7 wherein the one or more adhesive damping pads comprises a constrained damping layer material.
